(19) United States
(12) Patent Application Publication
(10) Pub. No.: US 2013/0000651 A1
(43) Pub. Date: Jan. 3, 2013

(54) DEVICE FOR REVERSING SYMPTOMATIC HEMORRHOIDS

(76) Inventor: Sergio Adrian Pleszowski, Montevideo (UY)

(21) Appl. No.: 13/583,735

(22) PCT Filed: Aug. 23, 2010
(86) PCT No.: PCT/BR10/00278

§ 371 Date: Sep. 10, 2012

(51) Int. Cl. A61G 15/12

(52) U.S. Cl. 128/845

(57) ABSTRACT

The invention relates to a therapeutic device which reverses symptomatic hemorrhoids.

The device comprises a volumetric object and is formed by a base supporting stairs of different heights. An element is disposed between the two stairs; said element is quite taller than the stairs.

When used, the device reverses or alleviates hemorrhoids symptoms, due to the force of gravity.

Hereinafter a utility model is described for the purposes of understanding the implicit solution herein proposed:

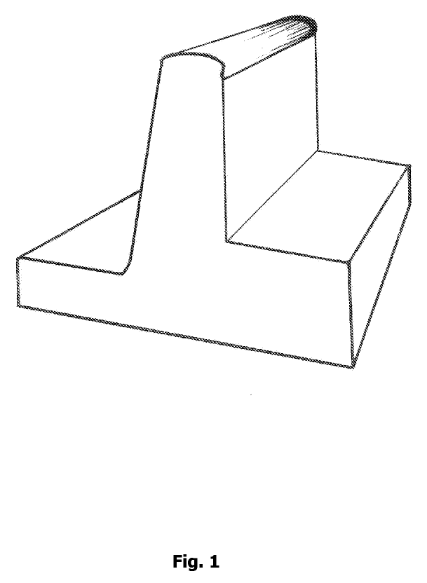

FIG. 1 represents a perspective view of the device for reversing symptomatic hemorrhoids (as must be placed when used): two stairs each having a different height can be observed onto a rectangular base. Between them stands an element considerably higher than both stairs which comprises a third horizontal surface counting said two stairs, which can support the middle part of the body (mainly the hip) of a patient that uses the device herein proposed.

This device offers an effective solution to any and all undesired symptoms arising from “hemorrhoids”, whatever its etiology.

If properly used, the device for reversing symptomatic hemorrhoids can reverse and thus alleviate rapidly and effectively hemorrhoids symptoms due to its use of the effects of the Law of Gravity.

The way the stairs are situated onto the device herein proposed provides support for part of lower and upper limbs of patients.

In order to comfortably support the weight of the middle part of a human's body, the surface of the object located toward the middle of the device (between the two stairs) has a coating or layer softer than that of the stairs.

Furthermore, this device for reversing symptomatic hemorrhoids may be changed from time to time as far as design is concerned, with the purpose of optimizing its use.

External dimensions of the device herein proposed will allow its use by a broad universe of individuals once it becomes available. For the production of this utility model different materials may be used, which can be more or less rigid.

User rests part of their lower and upper limbs onto the surfaces of the stairs shown in FIG. 1 and the hip region rests onto the surface located in the middle of the device, thus achieving the reversal of the hemorrhoids symptoms rapidly and effectively.

What is claimed is:

1. A device for reversing symptomatic hemorrhoids essentially characterized by comprising a volumetric object with rectangular base whose smaller sides limit two stairs each having a different height, which limit a prominent semi-trapezoidal object situated toward the middle of the device, parallelly located to said stairs, and the soft surface of the prominent semi-trapezoidal object may serve as a support cushion to the middle part of the patient's body (mainly anterior superior iliac spine and anterior inferior iliac spine) thus achieving that the middle part of the body of a suffering patient be laid at a height higher than that of their upper extremities, the two stairs being of support for either lower and upper limbs of a patient, all the aforementioned quickly reversing hemorrhoids symptoms due to the force of gravity.
